(19) United States
(12) Patent Application Publication
(10) Pub. No.: US 2023/0232222 A1
(43) Pub. Date: Jul. 20, 2023

(54) USER TERMINAL, AUTHENTICATION TERMINAL, REGISTRATION TERMINAL, MANAGEMENT SYSTEM AND PROGRAM

(71) Applicant: NIPPON TELEGRAPH AND TELEPHONE CORPORATION, Tokyo (JP)

(72) Inventors: Shigenori OHASHI, Musashino-shi (JP); Tatsurou ISHIDA, Musashino-shi (JP); Atsushi NAKADAIRA, Musashino-shi (JP); Shigeru FUJIMURA, Musashino-shi (JP); Masayoshi CHIKADA, Musashino-shi (JP); Junichi KISHIGAMI, Muroran-shi (JP)

(73) Assignee: NIPPON TELEGRAPH AND TELEPHONE CORPORATION, Tokyo (JP)

(21) Appl. No.: 18/010,313

(22) PCT Filed: Jul. 1, 2021
(86) PCT No.: PCT/JP2021/025001

§ 371 Date: Dec. 14, 2022

(30) Foreign Application Priority Data
Jul. 1, 2020 (JP) 2020-113934

(51) Int. Cl. H04W 12/06; H04W 60/00; H04L 9/32

(52) U.S. Cl. CPC H04W 12/06; H04W 60/00; H04L 9/3213

(57) ABSTRACT

A user terminal according to the present embodiment is a user terminal connectable to a first distributed ledger network and a second distributed ledger network, and includes a generation unit, a first control unit, and a second control unit. The generation unit generates a decentralized identifier related to a user using a verification key. The first control unit generates a registration transaction including the verification key and the decentralized identifier, and transmits the registration transaction to the first distributed ledger network. The second control unit generates a token transaction related to issuance of a token, the token transaction including data of the user and the decentralized identifier, and transmits the token transaction to the second distributed ledger network.

### FIELD

The present invention relates generally to a user terminal, an authentication terminal, a registration terminal, a management system, and a program, using a distributed ledger technology.

### BACKGROUND

In transactions of cryptocurrency such as Bitcoin (registered trademark), a blockchain, which is a type of decentralized distributed ledger technology, is used. Since the blockchain has a high robustness against tampering, it has been considered to be used for various applications such as smart contracts capable of executing various contracts and transactions in addition to cryptocurrency. An example of a programmable blockchain that can handle smart contracts is Ethereum, on which general-purpose decentralized applications can run.

Since a distributed ledger technology capable of realizing various smart contracts has a data structure in which transactions are grouped into blocks and the blocks are associated with each other by hashes, a distributed ledger technology is not suitable for management of files having a large data size.

As a decentralized file management method, there is a storage that manages a file with a unique identifier (ID) created from a content hash or the like (see, for example, Non. Patent Literature 1). There is also a method of registering a file in that storage and recording an ID of the file in a distributed ledger for management (see, for example, Non Patent Literature 2).

Further, a method of managing a decentralized identifier (DID) created by an individual, in addition to the ID of the file, on Ethereum has been studied.

### CITATION LIST

### Non Patent Literatures

Non Patent Literature 1: Juan Banet, “IPFS-Content Addressed, Versioned, P2P File System (DRAFT 3)”, [online], [search on Feb. 27, 2020], Internet <URL:

https://ipfs.io/ipfs/QmR7GSQM93Cx5eAg6a6yRzNde1FQv7uL6X1o4k 7zrJa3LX/ipfs.draft3.pdf>

Non Patent Literature 2: Mathis Steichen, et al., “Blockchain-Based, Decentralized Access Control for IPFS”, [online], [search on Feb. 27, 2020], Internet <URL:

https://www.researchgate.net/publication/327034734_Blockcha in-Based_Decentralized_Access_Control for IPFS>

### SUMMARY

### Technical Problem

If DID and file management are performed by a distributed ledger, it is assumed that the DID and file metadata are managed by a contract registered in a programmable blockchain such as Ethereum and the file is managed in an external storage or an external distributed file storage. That is, a contract for managing the DID requires an administrator.

However, a management structure requiring an administrator can be a single point of failure. In particular, unlike the management of file metadata, since the DID is information with a high degree of commonality, a management structure that depends on a specific administrator is not appropriate for managing the DID.

The present invention has been made in view of the above circumstances, and an object thereof is to provide a user terminal, an authentication terminal, a registration terminal, a management system, and a program capable of realizing robust and flexible information management.

### Solution to Problem

To achieve the above-described object, a user terminal according to an aspect of the present invention connectable to a first distributed ledger network and a second distributed ledger network. The user terminal includes a generation unit, a first control unit and a second control unit. The generation unit is configured to generate a decentralized identifier related to a user using a verification key. The first control unit is configured to generate a registration transaction including the verification key and the decentralized identifier, and transmit the registration transaction to the first distributed ledger network. The second control unit is configured to generate a token transaction related to issuance of a token, the token transaction including data of the user and the decentralized identifier, and transmit the token transaction to the second distributed ledger network.

An authentication terminal according to an aspect of the present invention is connectable to a first distributed ledger network and a second distributed ledger network. The first distributed ledger network is a network in which a decentralized identifier related to a user and a verification key associated with the decentralized identifier are stored in a distributed ledger. The second distributed ledger network is a network in which a token including encrypted data related to the user is stored in a distributed ledger. The authentication terminal includes an acquisition unit, a first control unit, a second control unit, a decryption unit and a verification unit. The acquisition unit is configured to acquire the decentralized identifier, personal identification information related to the user, and a decryption key. The first control unit is configured to extract the verification key associated with the decentralized identifier by referring to the first distributed ledger network. The second control unit is configured to extract the encrypted data to be authenticated using access information to the token by referring to the second distributed ledger network. The decryption unit is configured to decrypt the encrypted data using the decryption key. The verification unit is configured to verify a signature attached to the token using the verification key, and verify decrypted data using the personal identification information.

A registration terminal according to an aspect of the present invention is connectable to a first distributed ledger network and a second distributed ledger network. The first distributed ledger network is a network in which a decentralized identifier related to a user and a verification key associated with the decentralized identifier are stored in a distributed ledger. The second distributed ledger network is a network in which a token including encrypted data related to the user is stored in a distributed ledger. The registration terminal includes a generation unit, an encryption unit, a control unit and a transmission unit. The generation unit is configured to generate additional information newly associated with the decentralized identifier. The encryption unit is configured to encrypt the additional information. The control unit is configured to generate a registration transaction for associating encrypted additional information with the token, and transmit the registration transaction to the second distributed ledger network. The transmission unit is configured to transmit access information to the token associated with the additional information and a decryption key for decrypting the encrypted additional information.

A management system according to an aspect of the present invention includes a user terminal and an authentication terminal capable of accessing a first distributed ledger network and a second distributed ledger network. The user terminal includes a generation unit, an encryption unit, a first control unit and a second control unit. The generation unit is configured to generate a decentralized identifier related to a user using a verification key. The encryption unit is configured to encrypt data of the user. The first control unit is configured to generate a registration transaction including the verification key and the decentralized identifier, and transmit the registration transaction to the first distributed ledger network. The second control unit is configured to generate a token transaction related to issuance of a token, the token transaction including encrypted data of the user and the decentralized identifier, and transmit the token transaction to the second distributed ledger network. The authentication terminal includes an acquisition unit, a first control unit, a second control unit, a decryption unit and a verification unit. The acquisition unit is configured to acquire the decentralized identifier, personal identification information related to the user, and a decryption key from the user terminal. The first control unit is configured to extract the verification key associated with the decentralized identifier by referring to the first distributed ledger network. The second control unit is configured to extract the encrypted data to be authenticated using access information to the token by referring to the second distributed ledger network. The encryption unit is configured to decrypt the encrypted data using the decryption key. The verification unit is configured to verify a signature attached to the token using the verification key, and verify decrypted data using the personal identification information.

### Advantageous Effects of Invention

According to the present invention, robust and flexible information management can be realized.

### BRIEF DESCRIPTION OF THE DRAWINGS

FIG. 1 is a conceptual diagram of a management system according to an embodiment.

FIG. 2 is a block diagram showing a user terminal according to the embodiment.

FIG. 3 is a block diagram showing an authentication terminal according to the embodiment.

FIG. 4 is a block diagram showing a registration terminal according to the embodiment.

FIG. 5 is a sequence diagram showing an example of DID registration processing performed by the management system according to the embodiment.

FIG. 6 is a sequence diagram showing an example of DID registration processing performed by the management system according to the embodiment.

FIG. 7 is a sequence diagram showing an example of DID authentication processing performed by the management system according to the embodiment.

FIG. 8 is a sequence diagram showing an example of recording processing of a DID authentication result performed by the management system according to the embodiment.

FIG. 9 is a sequence diagram showing an example of DID registration processing in the management system in a case where additional information is registered in a DID.

FIG. 10 is a sequence diagram showing an example of DID registration processing in the management system in the case where additional information is registered in a DID.

FIG. 11 is a sequence diagram showing an example of a process of checking additional information performed by the management system according to the embodiment.

### DETAILED DESCRIPTION

Hereinafter, a user terminal, an authentication terminal, a registration terminal, a management system, and a program according to an embodiment of the present disclosure will be described in detail with reference to the drawings. In the embodiment described below, components denoted by the same reference numerals are assumed to perform the same operations, and redundant description thereof will be omitted.

A management system according to the present embodiment will be described with reference to a conceptual diagram of FIG. 1.

A management system 10 according to the present embodiment includes a user terminal 1, an authentication terminal 2, a storage service 8, a first distributed ledger network 4, a second distributed ledger network 5, and a registration terminal 3.

The user terminal 1 is a terminal that generates a decentralized identifier (DID) and generates data (also referred to as association data) to be associated with the DID. In the present embodiment, the association data is assumed to be, for example, data related to an individual including the person himself/herself, an organization, or an object, or metadata attached to that data, but may be any data as long as it makes sense for it to be managed in association with the DID.

The user terminal 1 is connectable to the first distributed ledger network 4, the second distributed ledger network 5, and the storage service 8. The user terminal 1 manages accounts respectively connectable to the first distributed ledger network 4, the second distributed ledger network 5, and the storage service 8, signature keys associated with the accounts, and corresponding verification keys. As the signature keys, a value common to the first distributed ledger network 4, the second distributed ledger network 5, and the storage service 8 may be used, or values different from each other may be used. The signature keys may be stored in a storage 12 of the user terminal 1, a subscriber identity module (SIM), or the like, or may be managed in a storage location different from the user terminal 1, such as a cloud server, a dedicated device, or paper.

The authentication terminal 2 is a terminal that authenticates an association between the DID generated by the user terminal 1 and a token generated on the second distributed ledger network 5. In the present embodiment, the authentication terminal 2 is assumed to be an authentication authority having a social position, but is not limited thereto, and may be an authority, an organization, or an individual that performs genuine authentication. The authentication terminal 2 can access the first distributed ledger network 4, the second distributed ledger network 5, and the storage service 8.

Similarly to the user terminal 1, the authentication terminal 2 also manages the signature keys associated with the accounts connectable to the first distributed ledger network 4 and the second distributed ledger network 5.

The registration terminal 3 is a terminal that generates new information (hereinafter referred to as additional information) to be associated with the DID generated by the user terminal 1. Similarly to the user terminal 1 or the authentication terminal 2, the registration terminal 3 can also access the first distributed ledger network 4, the second distributed ledger network 5, and the storage service 8. Furthermore, the registration terminal 3 manages the signature keys associated with the accounts connectable to the first distributed ledger network 4 and the second distributed ledger network 5.

The first distributed ledger network 4 is a network using a decentralized distributed ledger technology that does not require a specific administrator. Here, the first distributed ledger network 4 is assumed to be a blockchain network such as Namecoin in which data can be registered in a key-value store format. However, the first distributed ledger network 4 may be a distributed ledger technology in which at least two elements can be managed in association with each other by a distributed ledger and which does not include processing registered a posteriori by a specific administrator in the process of verification, execution, and registration in the ledger of a transaction.

The second distributed ledger network 5 is a network using a logical centralized distributed ledger technology that requires a specific administrator. Here, the second distributed ledger network 5 is assumed to be a blockchain network such as EOS or Ethereum capable of realizing a decentralized application (DApps) related to application of a blockchain such as a smart contract.

However, the second distributed ledger network 5 may be a network using a distributed ledger technology in which registration and management of a program executed by a transaction are performed a posteriori by a specific administrator.

The storage service 8 is a service for managing personal information, etc. acquired from the user terminal 1 as a file in a database or the like. If a file is registered, the storage service 8 issues a registration identifier (registration ID) of that file. The registration ID is an identifier for uniquely identifying that file, and is also referred to as a file identifier. The storage service 8 may be a centralized type in which a server (not shown) manages files, or may be a decentralized type in which terminals involved in maintaining the storage service 8 are distributed and files are managed in a peer-to-peer (P2P) network, such as an interplanetary file system (IPFS) or Swarm.

Note that, in the present embodiment, the first distributed ledger network 4 and the second distributed ledger network 5 are assumed to be different independent networks, but the first distributed ledger network 4 and the second distributed ledger network 5 may be formed by one distributed ledger network as long as a layer of data processing that is inherent in the infrastructure and that does not require a specific administrator and a layer of data processing by a program registered a posteriori by a specific administrator can be distinguished and used.

The user terminal 1, the authentication terminal 2, and the registration terminal 3 may belong to the first distributed ledger network 4 and the second distributed ledger network 5 and have node functions for maintaining these networks. A node function is a function of performing verification processing and confirmation processing of a transaction, and updating and holding ledger information (block information, a state database, etc.).

In addition to the user terminal 1, the authentication terminal 2, and the registration terminal 3, terminals (referred to as other nodes) that replace the node functions may be present in the first distributed ledger network 4 and the second distributed ledger network 5. In the example of FIG. 1, other nodes 6 that maintain the first distributed ledger network 4 may be present, and other nodes 7 that maintain the second distributed ledger network 5 may be present. The user terminal 1, authentication terminal 2, and registration terminal 3 may not include the node functions if the other nodes 6 and the other nodes 7 that replace the node functions are present. In the present embodiment, a case where the user terminal 1, authentication terminal 2, and registration terminal 3 execute the node functions will be described.

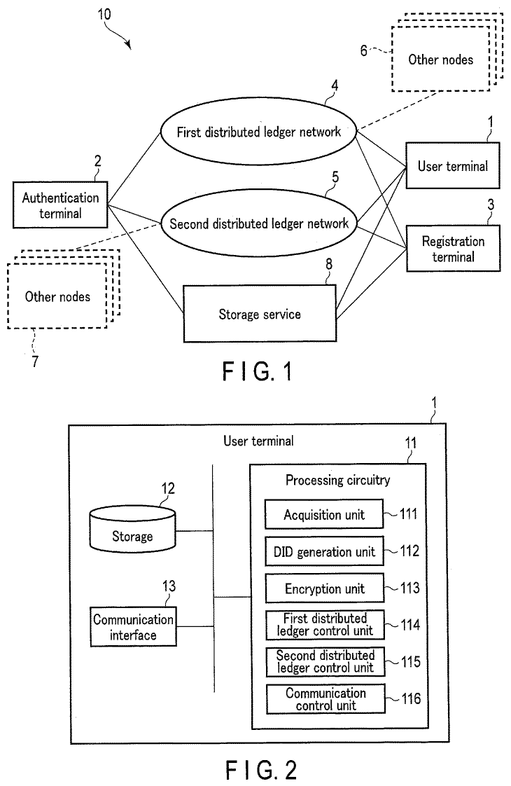

Next, the user terminal 1 according to the present embodiment will be described with reference to the block diagram of FIG. 2.

The user terminal 1 includes processing circuitry 11, the storage 12, and a communication interface 13. The processing circuitry 11 includes an acquisition unit 111, a generation unit 112, an encryption unit 113, a first distributed ledger control unit 114, a second distributed ledger control unit 115, and a communication control unit 116.

The acquisition unit 111 acquires personal information to be associated with a DID and a file to be registered in the storage service 8. Further, the acquisition unit 111 acquires a registration ID from the storage service 8.

The generation unit 112 generates a signature key for a DID and a verification key corresponding to the signature key. The generation unit 112 generates a DID related to a user using the verification key. Further, the generation unit 112 may generate association data to be associated with the DID.

The encryption unit 113 encrypts the association data. An encryption scheme is assumed to be, for example, a symmetric key encryption scheme using a symmetric key, but any scheme may be used as long as it is an encryption scheme in which security strength is guaranteed.

The first distributed ledger control unit 114 generates a registration transaction including the DID and the verification key. The first distributed ledger control unit 114 transmits the registration transaction to the first distributed ledger network 4. Further, the first distributed ledger control unit 114 executes a node function for maintaining the first distributed ledger network. If personal information is registered in the storage service 8, the first distributed ledger control unit 114 includes a registration ID issued from the storage service 8 in the registration transaction.

The second distributed ledger control unit 115 generates a token transaction related to token data including a message to be signed including data of the user and the DID and a signature value obtained by digitally signing that message to be signed with the signature key of the user. The token data is data related to issuance of a token. The second distributed ledger control unit 115 transmits the token transaction to the second distributed ledger network 5. The second distributed ledger control unit 115 executes a node function similarly to the first distributed ledger control unit 114.

The communication control unit 116 controls data communication between the storage service 8, the first distributed ledger network 4, and the second distributed ledger network 5. In particular, if the communication control unit 116 performs a process of transmitting data to the storage service 8 and receiving a registration ID related to the data, the communication control unit 116 is also referred to as a registration unit.

The storage 12 stores ledger data of the first distributed ledger network 4 and the second distributed ledger network 5, a key pair for transaction issuance, a key pair for association certification, a file, an identifier (also referred to as a registration transaction ID) of a registration transaction issued by itself, access information to a token, etc. The access information to the token is information for referring to information stored in the token or information stored in the token transaction used for token generation, and specifically includes, for example, an identifier of the token transaction (also referred to as a token transaction ID), a contract address, interface information for access, and an ID to be manually or automatically assigned to the token.

The communication interface 13 is an interface for performing data communication with the first distributed ledger network 4, the second distributed ledger network 5, and the storage service 8. As the communication interface 13, a generally used communication interface may be used, and thus a description thereof is omitted here.

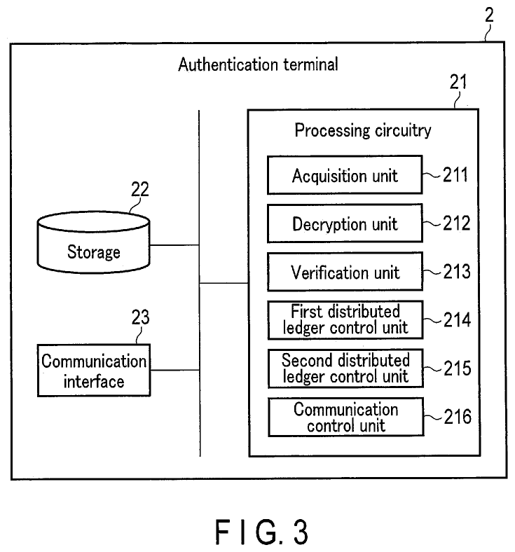

Next, the authentication terminal 2 according to the present embodiment will be described with reference to a block diagram of FIG. 3.

The authentication terminal 2 includes processing circuitry 21, a storage 22, and a communication interface 23. The processing circuitry 21 includes an acquisition unit 211, a decryption unit 212, a verification unit 213, a first distributed ledger control unit 214, a second distributed ledger control unit 215, and a communication control unit 216.

The acquisition unit 211 acquires, for example, a DID, personal identification information, and a decryption key as an authentication request from the user terminal 1. The personal identification information may be information obtained from a document for certifying an identity, such as a driver's license, an insurance card, or a passport, which is requested by a service using the DID. The decryption key is a key for decrypting encrypted association data.

The decryption unit 212 decrypts the encrypted association data by using the decryption key.

The verification unit 213 verifies a signature attached to the token using a verification key, and verifies the decrypted association data using the personal identification information.

The first distributed ledger control unit 214 extracts the verification key by referring to the first distributed ledger network 4.

The second distributed ledger control unit 215 extracts the encrypted association data to be authenticated using the access information to the token by referring to the second distributed ledger network 5.

The first distributed ledger control unit 214 and the second distributed ledger control unit 215 realize node functions similar to those of the first distributed ledger control unit 114 and the second distributed ledger control unit 115 of the registration terminal, respectively.

The communication control unit 216 controls data communication between the first distributed ledger network 4, the second distributed ledger network 5, and the storage service 8.

The storage 22 stores the ledger data of the first distributed ledger network 4 and the second distributed ledger network 5, a key pair for transaction issuance, access information to a token, a registration transaction ID as necessary, or the like.

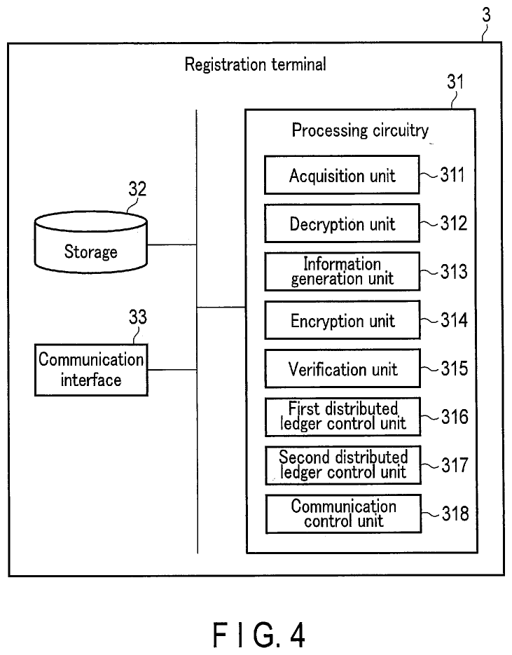

The communication interface 23 performs approximately the same processing as that of the communication interface 13 of the user terminal 1. Next, the registration terminal 3 according to the present embodiment will be described with reference to the block diagram of FIG. 4.

The registration terminal 3 includes processing circuitry 31, a storage 32, and a communication interface 33. The processing circuitry 31 includes an acquisition unit 311, a decryption unit 312, an information generation unit 313, an encryption unit 314, a verification unit 315, a first distributed ledger control unit 316, a second distributed ledger control unit 317, and a communication control unit 318.

The acquisition unit 311 receives a DID, a decryption key, personal identification information, access information to a token, etc. from the user terminal 1.

Similarly to the decryption unit 212, the decryption unit 312 decrypts encrypted association data using the decryption key.

The information generation unit 313 generates additional information to be newly associated with the DID separately from the association data.

The encryption unit 314 encrypts the additional information. As an encryption scheme, a scheme similar to that of the encryption unit 113 may be used.

Similarly to the verification unit 213, the verification unit 315 verifies a signature attached to the token using a verification key, and verifies the decrypted association data using the personal identification information.

The first distributed ledger control unit 316 extracts the verification key associated with the DID by referring to the first distributed ledger network 4.

The second distributed ledger control unit 317 extracts the encrypted association data to be authenticated by using the access information to the token by referring to the second distributed ledger network 5.

The first distributed ledger control unit 316 and the second distributed ledger control unit 317 realize node functions similar to those of the first distributed ledger control unit 114 and the second distributed ledger control unit 115 of the registration terminal, respectively.

The communication control unit 318 controls data communication between the first distributed ledger network 4, the second distributed ledger network 5, and the storage service 8.

The storage 32 stores ledger data of the first distributed ledger network 4 and the second distributed ledger network 5, a key pair for transaction issuance, the access information to the token, etc.

The communication interface 33 performs approximately the same processing as that of the communication interface 13 of the user terminal 1.

The processing circuitry 11 of the user terminal 1, the processing circuitry 21 of the authentication terminal 2, and the processing circuitry 31 of the registration terminal 3 are each formed of a processor such as a central processing unit (CPU) or a graphics processing unit (GPU), or an integrated circuit such as a field programmable gate array (FPGA) or an application specific integrated circuit (ASIC). Each unit of the processing circuitry 11 and the processing circuitry 21 described above may be realized as one function of a processor or an integrated circuit by the processor or the integrated circuit executing a processing program.

In addition, the storage 12 of the user terminal 1, the storage 22 of the authentication terminal 2, and the storage 32 of the registration terminal 3 are each formed of a generally used storage medium such as a hard disk drive (HDD), a solid state drive (SSD), or a flash memory.

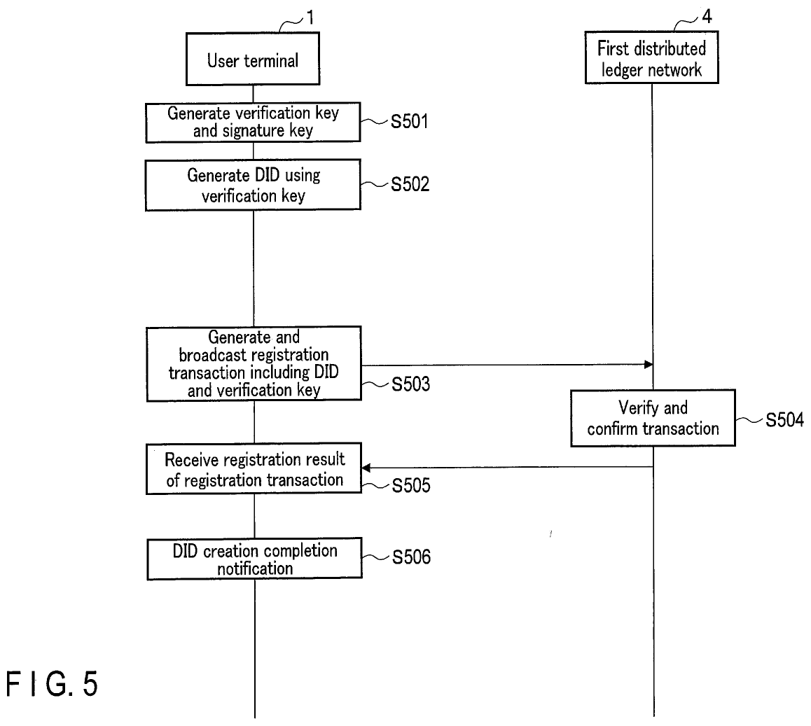

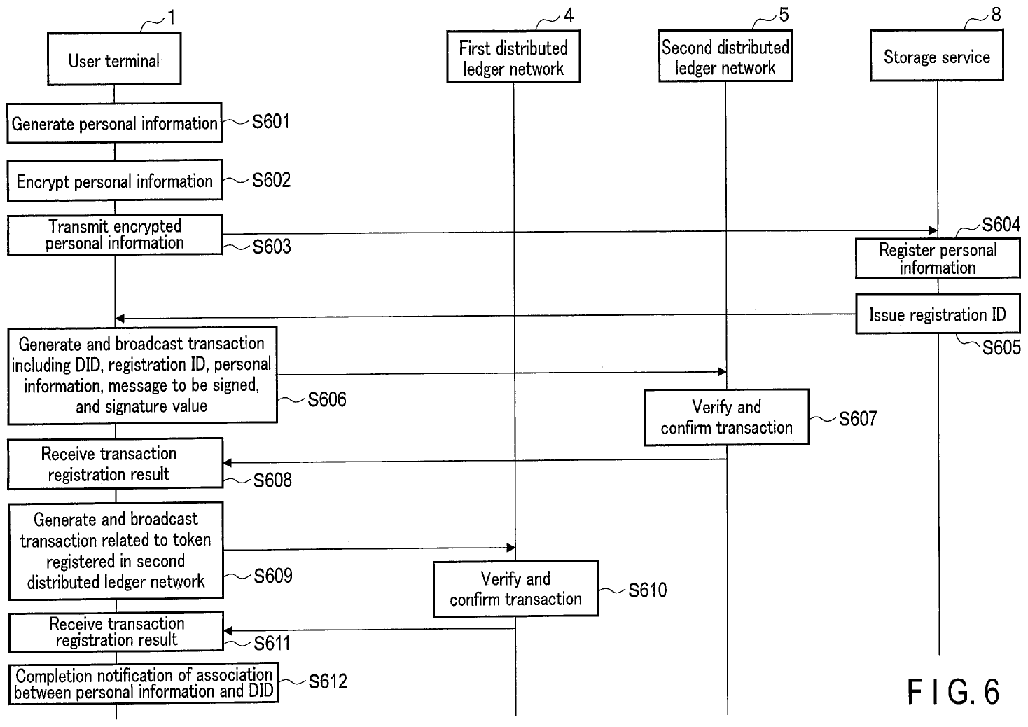

Next, DID registration processing in the management system 10 according to the present embodiment will be described with reference to the sequence diagrams of FIGS. 5 and 6.

FIG. 5 is a sequence showing a time series related to data transmission and reception between the user terminal 1 and the first distributed ledger network 4. Although the same applies to the sequence diagrams of FIGS. 5 to 11 below, terminals that are not shown (the user terminal 1, the authentication terminal 2, and the registration terminal 3) may also participate as nodes in order to maintain the first distributed ledger network 4 and the second distributed ledger network 5. In the example of FIG. 5, the authentication terminal 2 and the registration terminal 3 may serve as nodes to verify and confirm a transaction in the first distributed ledger network 4.

In step S501, the generation unit 112 of the user terminal 1 generates a signature key for a DID and a verification key corresponding to the signature key.

In step S502, the generation unit 112 of the user terminal 1 creates a DID using the verification key. For example, a hash value of the verification key may be the DID. Note that a hash value of the hash value of the verification key, i.e., a double hash, may be used as the DID, or any value may be used as the DID as long as it is a uniquely identifiable value that does not cause a collision of values.

In step S503, the first distributed ledger control unit 114 of the user terminal 1 generates a registration transaction including the DID and the verification key. In order to make the registration transaction a valid transaction, the first distributed ledger control unit 114 digitally signs the registration transaction with the signature key generated to use the first distributed ledger network 4, and broadcasts the digitally signed registration transaction to the first distributed ledger network 4.

In step S504, a plurality of terminals having node functions in the first distributed ledger network 4 verify the registration transaction according to the consensus algorithm. If that registration transaction satisfies a predetermined requirement, the registration transaction is added to a block. Here, assuming that the registration transaction satisfies a predetermined requirement, the registration transaction is confirmed by the first distributed ledger network 4.

In step S505, the first distributed ledger control unit 114 of the user terminal 1 receives a registration result of the registration transaction from the first distributed ledger network 4. The registration result is, for example, a registration transaction and a confirmation result (True or False or a status code), and if the registration transaction is registered in a block, a block number thereof.

In step S506, for example, the communication control unit 116 of the user terminal 1 notifies the user of the user terminal 1 of completion of the DID creation. The notification method may be any method such as displaying the creation completion on a screen, notifying by voice or sound, or the like.

Next, FIG. 6 is a sequence showing a time series related to data transmission and reception among the user terminal 1, the first distributed ledger network 4, the second distributed ledger network 5, and the storage service 8.

In the following examples shown in FIGS. 6 to 9, personal information such as individual information of the user, for example, is assumed as association data. It is also assumed that metadata of encrypted personal information is included in a token, and the encrypted personal information itself (or the remaining data of the personal information included in the token) is registered as a file in the storage service 8.

In step S601, the generation unit 112 of the user terminal 1 creates personal information. Here, personal information and metadata of the personal information are created.

In step S602, the encryption unit 113 of the user terminal 1 encrypts the personal information and the metadata of the personal information created in step S601 with a common key.

In step S603, the communication control unit 116 of the user terminal 1 transmits the encrypted personal information to the storage service 8 via the communication interface 13.

In step S604, the storage service 8 registers the encrypted personal information, and management is started.

In step S605, the storage service 8 issues an ID for the registered personal information (hereinafter referred to as a registration ID). The registration ID may be, for example, a character string generated from a hash value of a file such as a fingerprint, or an ID including a phrase indicating a service provider in addition to the character string generated from the hash value.

Alternatively, an identifier such as a uniform resource identifier (URI) may be used. That is, it suffices that an identifier capable of uniquely identifying the registered personal information is issued. Upon receiving the registration ID by the communication control unit 116 of the user terminal 1, the registration processing of the personal information to the storage service 8 is completed.

In step S606, a token transaction is generated which includes the DID (or the hash value of the DID), message to be signed relating to token issuance including the metadata of the encrypted personal information and the registration ID, and a signature value obtained by digitally signing the message to be signed with the signature key. In order to make the token transaction a valid transaction, the second distributed ledger control unit 115 of the user terminal 1 digitally signs the token transaction using the signature key generated to use the second distributed ledger network 5, and broadcasts the digitally signed token transaction to the second distributed ledger network 5.

In step S607, the second distributed ledger network 5 verifies the token transaction according to the consensus algorithm. If that token transaction satisfies a predetermined requirement, the token transaction is added to a block. Here, assuming that the token transaction satisfies the predetermined requirement, the token transaction is confirmed by the second distributed ledger network 5.

In step S608, for example, the second distributed ledger control unit 115 of the user terminal 1 receives a registration result of the token transaction from the second distributed ledger network 5. The registration result is, for example, a token transaction and a confirmation result (True or False or a status code), and if the token transaction is registered in a block, a block number thereof.

In step S609, information of the token confirmed on the second distributed ledger network 5 is associated with the DID already confirmed on the first distributed ledger network 4. Specifically, the first distributed ledger control unit 114 of the user terminal 1 generates a registration transaction including the DID and identification information of the token. The identification information of the token is, in other words, access information to the token, and includes a transaction ID assigned to the token transaction and a block number of a block into which the token transaction is captured. Further, a unique ID may be newly generated as the identification information of the token. For example, a unique ID generated by connecting a contract ID and a token identifier separated by a colon “:”, such as “Token:contract ID:token identifier”, may be used as the identification information of the token. In order to make the registration transaction a valid transaction, the first distributed ledger control unit 114 digitally signs the registration transaction with the signature key generated to use the first distributed ledger network 4, and broadcasts the digitally signed registration transaction to the first distributed ledger network 4.

In step S610, a plurality of terminals having node functions in the first distributed ledger network 4 verify the registration transaction according to the consensus algorithm. If that registration transaction satisfies a predetermined requirement, the registration transaction is added to a block. Here, assuming that the registration transaction satisfies the predetermined requirement, the registration transaction is confirmed by the first distributed ledger network 4.

In step S611, the first distributed ledger control unit 114 of the user terminal 1 receives a registration result of the registration transaction from the first distributed ledger network 4. The registration result is, for example, a registration transaction and a confirmation result (True or False or a status code), and if the registration transaction is registered in a block, a block number thereof.

In step S612, for example, the communication control unit 116 of the user terminal 1 notifies the user of completion of the association between the encrypted personal information and the DID.

In the example of FIG. 6, the encrypted personal information is registered in the storage service 8, but the encrypted personal information may not be registered in the storage service 8. In this case, since the message to be signed including the DID and the encrypted personal information and the signature value may be included in the token transaction, the processes from step S603 to step S605 shown in FIG. 6 will be omitted.

Alternatively, the encrypted personal information may be registered in the storage service 8, and the token transaction may include the registration ID without including the metadata of the encrypted personal information. In this case, in step S606, a token transaction including a message to be signed including the DID and the registration ID and a signature value is generated.

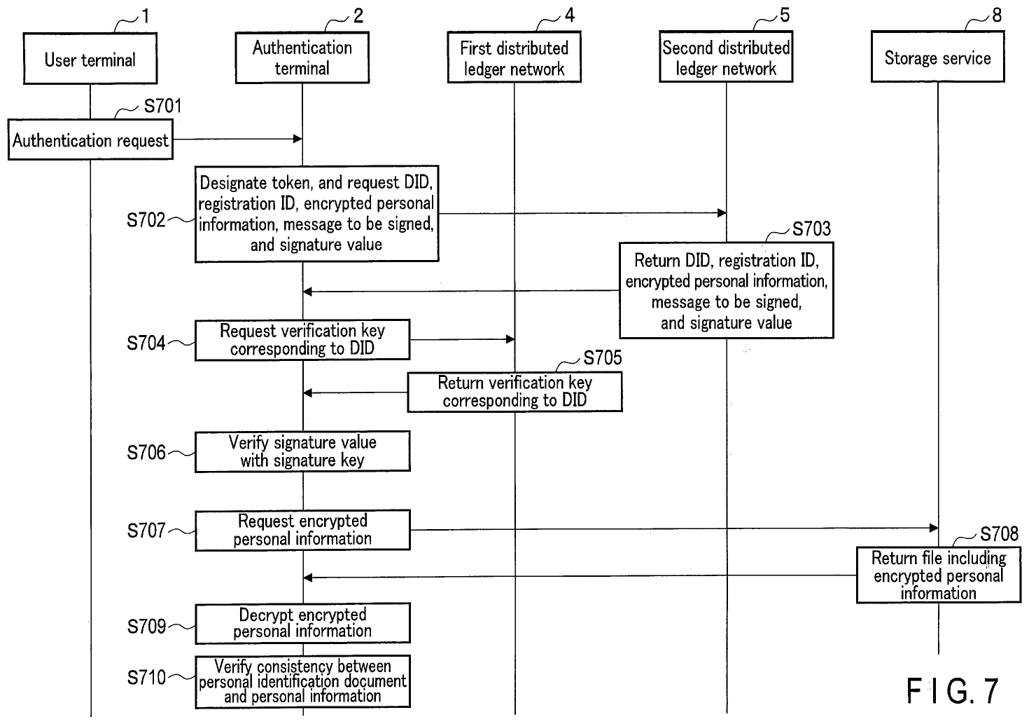

Next, DID authentication processing performed by the management system 10 according to the present embodiment will be described with reference to FIG. 7.

FIG. 7 is a sequence showing a time series related to data transmission and reception among the user terminal 1, the authentication terminal 2, the first distributed ledger network 4, the second distributed ledger network 5, and the storage service 8.

In FIG. 7, for convenience of description, “request” and “return” in the sequence are shown as if they access the first distributed ledger network 4 and the second distributed ledger network 5, but can also be realized by internal processing of the authentication terminal 2 without directly accessing the first distributed ledger network 4 and the second distributed ledger network 5. This is because, if each terminal (the user terminal 1, the authentication terminal 2, and the registration terminal 3) participates as a node in the first distributed ledger network 4 and the second distributed ledger network 5, the terminal itself serves as a part of the distributed ledger network. That is, by referring to a distributed ledger stored by each terminal, a transaction, various data, etc. matching a request of a verifier may be extracted.

In step S701, the user terminal 1 notifies the authentication terminal 2 of an authentication request. As the authentication request, for example, a DID of a user, a decryption key, personal identification information, and access information to a token may be reported by email or a message application. The decryption key is a key for decrypting metadata of encrypted personal information and the encrypted personal information registered in the storage service 8. If a DID is included in a token stored in the second distributed ledger network 5, the DID of the user may not be included in the information to be reported as the authentication request.

In step S702, the second distributed ledger control unit 215 of the authentication terminal 2 designates a token to be authenticated by using the access information of the token as a search key or the like, and requests the DID, a message to be signed including the metadata of the encrypted personal information and the registration ID, and a signature value thereof to the second distributed ledger network 5. Specifically, necessary information may be requested by using, for example, an API of a corresponding token or a token transaction.

In step S703, in response to the request from the authentication terminal 2, the second distributed ledger network 5 returns the DID, the message to be signed including the metadata of the encrypted personal information and the registration ID, and the signature value thereof. The processes of step S702 and step S703 may be executed as a process in which the second distributed ledger control unit 215 of the authentication terminal 2 extracts the DID, the metadata of the encrypted personal information, the registration ID, and the signature value by referring to the second distributed ledger network 5.

In step S704, the first distributed ledger control unit 214 of the authentication terminal 2 requests a verification key associated with the same DID as the extracted DID from the first distributed ledger network 4.

In step S705, the first distributed ledger network 4 returns the verification key corresponding to the DID in response to the request from the authentication terminal 2. The processes of step S704 and step S705 may be executed as a process in which the first distributed ledger control unit 214 of the authentication terminal 2 extracts the DID and the signature value by referring to the first distributed ledger network 4. In addition, for example, in a case where the first distributed ledger network 4 is realized by Bitcoin Core, a registration transaction matching a registration transaction ID may be searched from the ledger, and a verification key associated with the DID may be acquired from the registration transaction.

In step S706, the verification unit 213 of the authentication terminal 2 verifies the signature value with the verification key. For the verification of the signature value using the verification key, a general verification method in a digital signature may be used. If it is determined by the verification that the signature value is authentic, it can be determined that the token is an authentic token transmitted by the user to the second distributed ledger network 5, and if it is determined that the signature value is not authentic, it can be determined that the token is an unauthentic token.

In step S707, the communication control unit 216 of the authentication terminal 2 requests the encrypted personal information from the storage service 8 by designating the registration ID.

In step S708, the storage service 8 searches the database for the encrypted personal information corresponding to the registration ID, and transmits it to the authentication terminal 2.

In step S709, the decryption unit 212 of the authentication terminal 2 decrypts the metadata of the encrypted personal information and the encrypted personal information using the decryption key acquired in step S701.

In step S710, the verification unit 214 of the authentication terminal 2 verifies consistency between the decrypted personal information and a personal identification document. If the decrypted personal information and the content disclosed in the personal identification document are the same, it can be determined that the personal information is authentic. On the other hand, if the decrypted personal information and the content disclosed in the personal identification document are not the same, it can be determined that either the personal information or the personal identification document may be unauthentic.

If the encrypted personal information is not registered in the storage service 8, since the encrypted personal information is included in the token transaction and the encrypted personal information is returned in step S703, step S707 and step S708 may be omitted and that encrypted personal information may be decrypted in step S709.

On the other hand, if the encrypted personal information is registered in the storage service 8 and only the registration ID is included in the token transaction, the encrypted personal information is returned from the storage service 8 to the authentication terminal 2 in step 5708 based on the registration ID extracted in step S703, so that that encrypted personal information may be decrypted in step S709.

In addition, the authentication terminal 2 may directly or indirectly receive sharing of the registration transaction ID from the user terminal 1 in the first distributed ledger network 4, and store the shared registration transaction ID in the storage 22. The second distributed ledger control unit 215 can efficiently extract the verification key by referring to the shared registration transaction ID stored in the storage 22 in step S704. For example, in a case where a distributed ledger network of Bitcoin is utilized as the first distributed ledger network 4, if a registration transaction ID is shared, it is useful in extracting a verification key.

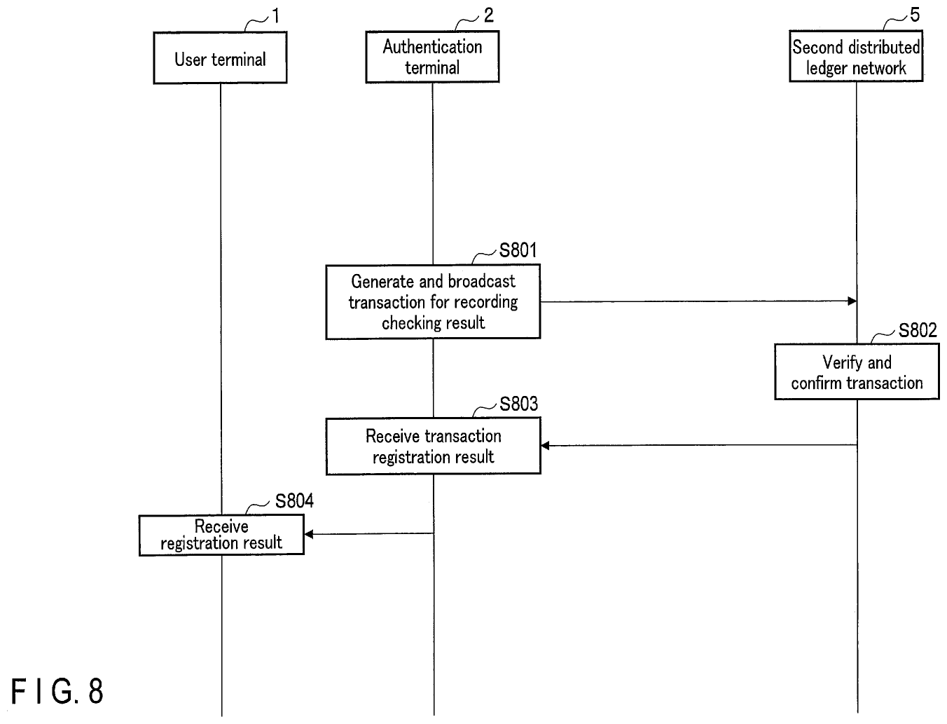

Next, recording processing of a DID authentication result performed by the management system 10 according to the present embodiment will be described with reference to the sequence diagram of FIG. 8.

FIG. 8 is a sequence showing a time series related to data transmission and reception among the user terminal 1, the authentication terminal 2, and the second distributed ledger network 5.

In step S801, the second distributed ledger control unit 215 of the authentication terminal 2 generates a registration transaction for recording a verification result. The generated registration transaction is assumed to be a transaction including an ID of an authenticating person, the date of authentication, a checking means indicating by what method personal information is checked, etc., but may be a transaction including other information such as the type of the checked personal information.

The second distributed ledger control unit 215 of the authentication terminal 2 digitally signs the generated registration transaction with the signature key generated to use the second distributed ledger network 5, and broadcasts the digitally signed registration transaction to the second distributed ledger network 5.

In step S802, the second distributed ledger network 5 verifies the registration transaction according to the consensus algorithm. If that registration transaction satisfies a predetermined requirement, the registration transaction is added to a block. Here, assuming that the registration transaction satisfies the predetermined requirement, the registration transaction is confirmed by the second distributed ledger network 5.

In step S803, the second distributed ledger control unit 215 of the authentication terminal 2 receives a registration result of the registration transaction from the second distributed ledger network 5. The registration result is, for example, a registration transaction and a confirmation result (True or False or a status code), and if the registration transaction is registered in a block, a block number thereof.

In step S804, for example, the acquisition unit 111 of the user terminal 1 receives the registration result from the authentication terminal 2. Accordingly, the user of the user terminal 1 can check that the information associated with the DID by the user is authenticated as correct information and is registered in the first distributed ledger network 4 and the second distributed ledger network 5.

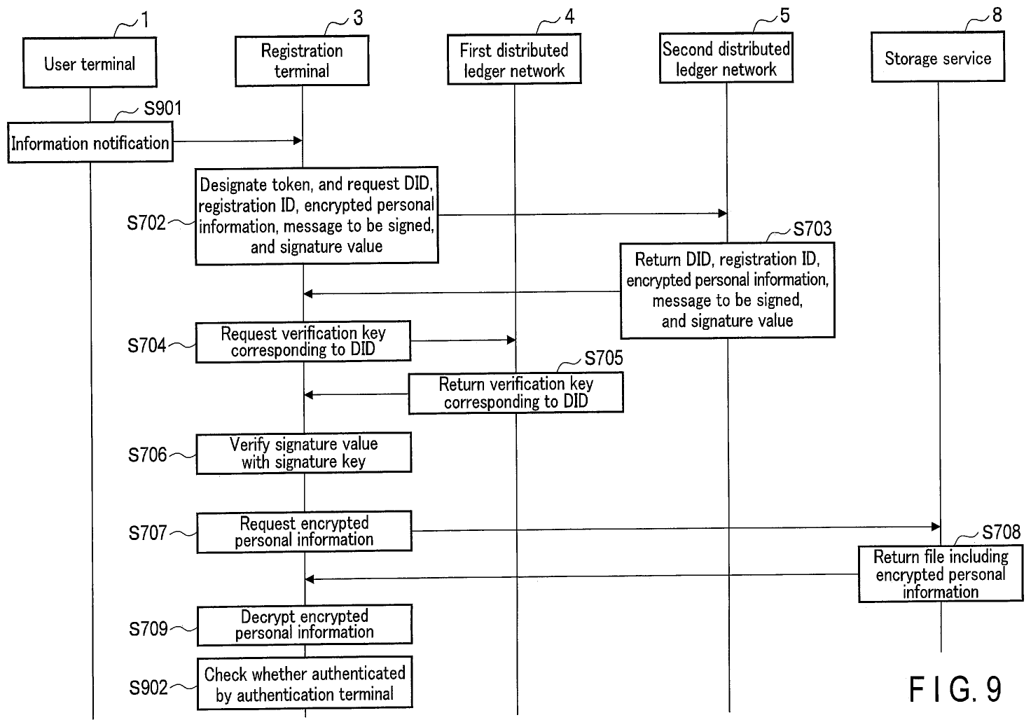

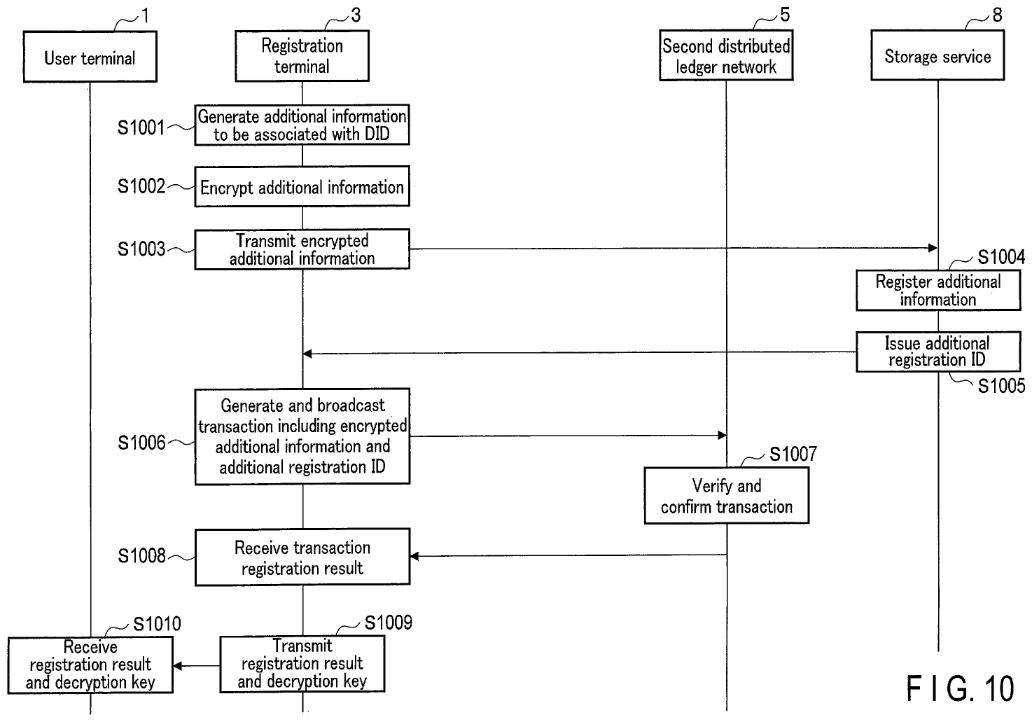

Next, DID registration processing in the management system 10 in a case where additional information is registered in a DID will be described with reference to FIGS. 9 and 10.

FIG. 9 is a sequence showing a time series related to data transmission and reception among the user terminal 1, the registration terminal 3, the first distributed ledger network 4, the second distributed ledger network 5, and the storage service 8.

In step S901, the user terminal 1 notifies the registration terminal 3 of information. Specifically, the acquisition unit 311 of the registration terminal 3 acquires a DID, a decryption key, personal identification information, and access information to a token.

Since the processes from step S702 to step S709 may be executed by the registration terminal 3 in the same manner as the processing of the authentication terminal 2 shown in FIG. 7, a description thereof is omitted here.

In step S902, whether or not the decrypted personal information has been authenticated by the authentication terminal 2 is checked. It is only necessary to be able to verify that the signature acquired from the token is authentic using the verification key in step S706, and further to check that the token has been authenticated by the authenticating person of the DID in step S901 and that the personal information to be associated with the information to be registered is correct by decrypting the personal information.

In step S901, the user terminal 1 may notify the registration terminal 3 of a signature certifying that the user is the owner of the DID. For example, a digital signature may be added to the DID, decryption key, and token access information reported from the user terminal 1. In this case, in step S902, the registration terminal 3 may verify the reported digital signature by the same method as in step S706, for example, and check that the user terminal 1 is the owner of the DID.

Next, FIG. 10 is a sequence showing a time series related to data transmission and reception among the user terminal 1, the registration terminal 3, the first distributed ledger network 4, the second distributed ledger network 5, and the storage service 8.

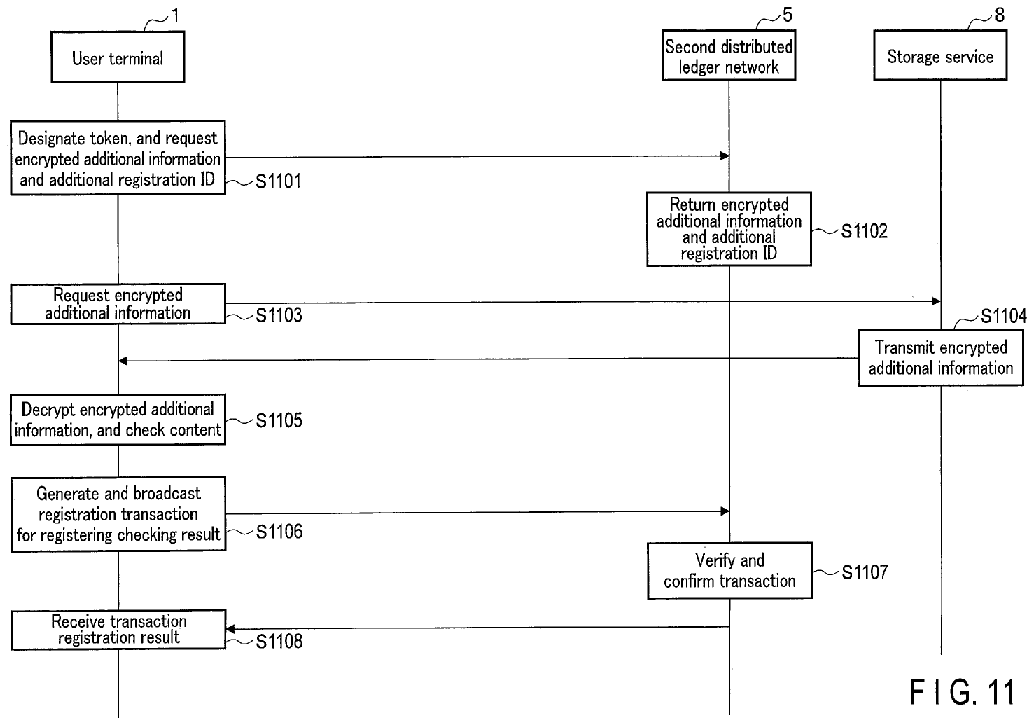

In FIGS. 10 and 11, it is assumed that metadata of encrypted additional information is included in a token and the encrypted additional information itself (or the remaining data of the additional information included in the token) is registered as a file in the storage service 8.

In step S1001, the information generation unit 313 of the registration terminal 3 generates additional information to be associated with a DID.

In step S1002, the encryption unit 314 of the registration terminal 3 encrypts the additional information. An encryption scheme may be the same as that in step S602.

In step S1003, the communication control unit 318 of the registration terminal 3 transmits the encrypted additional information to the storage service 8 via the communication interface 33.

In step S1004, the storage service 8 registers the encrypted additional information.

In step S1005, the storage service 8 issues an ID for the registered additional information (hereinafter referred to as an additional registration ID). The additional registration ID is assumed to have the same format as that of the registration ID.

In step S1006, the registration terminal 3 registers the encrypted additional information and the additional registration ID in a token on the second distributed ledger network 5. For example, the registration terminal 3 registers additional information metadata including the encrypted additional information or the additional registration ID in a token presented from the user terminal 1.

Alternatively, in order to newly create a token, a new token transaction including the encrypted additional information and the additional registration ID is generated, and that token transaction is broadcast. Here, it is assumed that a new token transaction is generated.

In step S1007, if a new token transaction is generated, the second distributed ledger network 5 verifies the token transaction according to the consensus algorithm. Here, it is assumed that the transaction is confirmed by the second distributed ledger network 5.

In step S1008, the second distributed ledger control unit 317 of the registration terminal 3 receives a registration result of the token transaction from the second distributed ledger network 5.

In step S1009, for example, the communication control unit 318 of the registration terminal 3 transmits the registration result and a decryption key for decrypting the encrypted additional information from the registration terminal 3.

In step S1010, for example, the acquisition unit 111 of the user terminal 1 receives the registration result and the decryption key from the registration terminal 3.

Next, the process of checking additional information performed by the management system 10 will be described with reference to the sequence diagram of FIG. 11.

FIG. 11 is a sequence showing a time series related to data transmission and reception among the user terminal 1, the first distributed ledger network 4, the second distributed ledger network 5, and the storage service 8.

In step S1101, in order to acquire additional information, the second distributed ledger control unit 115 of the user terminal 1 designates a token registered by the registration terminal 3 and requests encrypted additional information and an additional registration ID of a file registered in the storage service 8 from the second distributed ledger network 5.

In step S1102, metadata of the encrypted additional information and the additional registration ID are returned from the second distributed ledger network 5 in response to a request from the user terminal 1.

In step S1103, for example, the communication control unit 116 of the user terminal 1 uses the additional registration ID to request the storage service 8 to acquire the encrypted additional information corresponding to the additional registration ID.

In step S1104, the storage service 8 retrieves the encrypted additional information corresponding to the registration ID from the database, and transmits it to the user terminal 1.

In step S1105, the user terminal 1 decrypts the metadata of the encrypted additional information and the encrypted additional information using the decryption key acquired in step S1010 shown in FIG. 10. Thereafter, the user terminal 1 checks the content of the decrypted additional information. For the checking of the additional content, the user may check whether or not there is a problem with the additional information added by the registration terminal 3.

In step S1106, in order to register a checking result in step S1105, the second distributed ledger control unit 115 of the user terminal 1 generates a registration transaction including the checking result, and broadcasts the registration transaction to the second distributed ledger network 5.

In step S1107, the second distributed ledger network 5 verifies the registration transaction according to the consensus algorithm. If that registration transaction satisfies a predetermined requirement, the registration transaction is added to a block. Here, assuming that the registration transaction satisfies the predetermined requirement, the registration transaction is confirmed by the second distributed ledger network 5.

In step S1108, the second distributed ledger control unit 115 of the user terminal 1 receives a registration result of the registration transaction from the second distributed ledger network 5.

As for the additional information, the encrypted additional information may not be registered in the storage service 8 as in the case of the personal information described above. Alternatively, the encrypted additional information may be registered in the storage service 8, and the token transaction may include the additional registration ID without including the metadata of the encrypted additional information.

In addition, the registration result received in step S1108 may be associated with the registration transaction of the DID and the verification key registered in the first distributed ledger network 4.

Whether the personal information and the additional information associated with the DID are managed by the first distributed ledger network 4 or the second distributed ledger network 5 may be left to the user's selection.

According to the embodiment described above, information such as a DID with high commonality is managed by a decentralized distributed ledger network that does not require a specific administrator, and additional information, which is association data to be associated with the DID or new information, is managed by a logical centralized distributed ledger network that realizes DApps and requires a specific administrator.

Thus, it is possible to appropriately handle information having high commonality and information for a specific use. In addition, it is possible to manage open information and closed information by distinguishing them from each other according to the user's selection. The user can realize information control such as which information is disclosed to whom.

In addition, even if a DApps having various policies using the DID is increased or a policy of DApps is changed, a basic mechanism for verification is managed by the decentralized distributed ledger network. Thus, even if a failure of a service (contract) by one DApps occurs, such as a program bug or intentional or incidental destruction by an administrator, the failure does not become a single failure point and does not affect verification of authenticity of other services. As a result, robust and flexible information management can be realized.

The instructions indicated in the processing procedures shown in the above-described embodiment can be executed by a computer based on a software program.

In short, the present invention is not limited to the above-described embodiment as it is, and can be embodied by modifying the constituent elements without departing from the gist of the present invention in an implementation stage. Further, various inventions can be formed by appropriately combining a plurality of constituent elements disclosed in the above-described embodiment. For example, some constituent elements may be deleted from all the constituent elements indicated in the embodiment. Furthermore, constituent elements in different embodiments may be appropriately combined.

### REFERENCE SIGNS LIST

10: management system
1: user terminal
2: authentication terminal
3: registration terminal
4: first distributed ledger network
5: second distributed ledger network
6, 7: other nodes
8: storage service
11, 21, 31: processing circuitry
12, 22, 32: storage
13, 23, 33: communication interface
111, 211, 311: acquisition unit
112: generation unit
113, 314: encryption unit
114, 214, 316: first distributed ledger control unit
115, 215, 317: second distributed ledger control unit
116, 216, 318: communication control unit
212, 312: decryption unit
213, 315: verification unit
313: information generation unit

1. A user terminal connectable to a first distributed ledger network and a second distributed ledger network, the user terminal comprising processing circuitry configured to:
generate a decentralized identifier related to a user using a verification key;
generate a registration transaction including the verification key and the decentralized identifier; and
and transmit the registration transaction to the first distributed ledger network;
generate a token transaction related to issuance of a token, the token transaction including data of the user and the decentralized identifier; and
transmit the token transaction to the second distributed ledger network.

2. The user terminal according to claim 1, wherein the processing circuitry is further configured to:
register the data in a storage service, and receive a registration identifier issued for managing the data from the storage service; and
generate the registration transaction further including the registration identifier.

3. An authentication terminal connectable to a first distributed ledger network and a second distributed ledger network, the first distributed ledger network being a network in which a decentralized identifier related to a user and a verification key associated with the decentralized identifier are stored in a distributed ledger, the second distributed ledger network being a network in which a token including encrypted data related to the user is stored in a distributed ledger, the authentication terminal comprising processing circuitry configured to:
acquire the decentralized identifier, personal identification information related to the user, and a decryption key;
extract the verification key associated with the decentralized identifier by referring to the first distributed ledger network;
extract the encrypted data to be authenticated using access information to the token by referring to the second distributed ledger network;
decrypt the encrypted data using the decryption key; and
verify a signature attached to the token using the verification key, and verify decrypted data using the personal identification information.

4. The authentication terminal according to claim 3, wherein the processing circuitry is configured to generate a registration transaction including an identifier of an authenticating person and a verification result of the verification unit, and transmit the registration transaction to the second distributed ledger network.

5. A registration terminal connectable to a first distributed ledger network and a second distributed ledger network, the first distributed ledger network being a network in which a decentralized identifier related to a user and a verification key associated with the decentralized identifier are stored in a distributed ledger, the second distributed ledger network being a network in which a token including encrypted data related to the user is stored in a distributed ledger, the registration terminal comprising processing circuitry configured to:
generate additional information newly associated with the decentralized identifier;
encrypt the additional information;
generate a registration transaction for associating encrypted additional information with the token;
transmit the registration transaction to the second distributed ledger network; and
transmit access information to the token associated with the additional information and a decryption key for decrypting the encrypted additional information.

6. The registration terminal according to claim 5, wherein
the first distributed ledger network is a decentralized blockchain network not requiring a specific administrator, and
the second distributed ledger network is a logical centralized blockchain network requiring a specific administrator.

7-10. (canceled)

11. The user terminal according to claim 1, wherein
the first distributed ledger network is a decentralized blockchain network not requiring a specific administrator, and
the second distributed ledger network is a logical centralized blockchain network requiring a specific administrator.

12. The authentication terminal according to claim 3, wherein
the first distributed ledger network is a decentralized blockchain network not requiring a specific administrator, and
the second distributed ledger network is a logical centralized blockchain network requiring a specific administrator.
